(19) United States
(12) Patent Application Publication
(10) Pub. No.: US 2003/0107890 A1
(43) Pub. Date: Jun. 12, 2003

(54) Lamp string holding frame

(76) Inventor: Chih-Chen Chang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/004,870

(22) Filed: Dec. 7, 2001

(51) Int. Cl. F21S 4/00

(52) U.S. Cl. 362/249; 362/252

(57) ABSTRACT

The present invention provides a lamp string holding frame, which is a main frame shaped coordinating to the downward extension of said lamp string—vertical cord units, there are a proper number of retainers built on said main frame or the each wired lamp-holder for fastening them together. Due to applying said holding frames, the lamp string packaging process is made into normalization, so that the user can rapidly unfold the string cords and restore the original state.

### BACKGROUND OF THE INVENTION

1. Field of the Invention

The present invention relates to a lamp string holding frame, and more particularly to a holding frame used for retaining a decorating lamp string.

2. Description of Prior Art

In accordance with the conventional decorating lamp strings, as shown in FIG. 1 and FIG. 2, most of them are comprised of a proper number of small lamp-holders 1 and cords 2 wired into various styles lamp strings to create plenty of decorating effects, its base frame is composed of horizontal cord unit 9 and downward vertical cord units 8 extended from said horizontal cord unit 9, and several lamp-holders 1 built upon every unit; in accordance with this kind of lamp string, by connecting the horizontal cord units 9, to obtain extension from the both sides.

According to above-mentioned lamp strings, although unfold of it appears to beautiful, but in packaging process in manufacture, so far it just only is folded and tied the cords and piled together in the package for transportation. So the user wants to unfold it for using, due to tied and folded and piled cords together, the cords is easy kinked together so as to take the users much time to extend it, although it is extended after that, but the distorted cords by kinking are difficult to be restored into original so as to be loosed beauty sense.

### OBJECTS AND SUMMARY OF THE INVENTION

It is therefore a main object of the present invention to provide a lamp string holding frame so as to make the lamp string packaging normalization, in order that the user can rapidly unfold the string cords to restore the original state.

This object is achieved by a lamp string holding frame comprised of, coordinating to the downward vertical cord units, a main frame and lamp retainers built on the main frame or the said lamp-holder for fastening them together.

Due to utilizing above-mentioned construction, when packaging said lamp string in the manufacture, firstly, fasten the coordinating segment of decorating lamp string on the preformed holding frame by locating the lamp-holders in coordinating positions sequentially, then take a holding frame as an unit to fold the string cord stack-up in the package at all. In this way, said package can be normalized in specification, meanwhile the lamp string can be packaged into the standard package in normalization by fastening said lamp-holders to stereotype and locate the cords, so that the user can pick out the lamp string by one frame as an unit from the package without any kinking of said lamps or cords, and the user can save time and labors as spread the lamp string, meanwhile restore the original state rapidly.

### BRIEF DESCRIPTION OF THE DRAWINGS

FIG. 1 is a scheme showing the first of the decorating lamp string.

FIG. 2 is a scheme showing the second of the decorating lamp string.

FIG. 3 is a solid view showing of the present invention.

FIG. 4 is a scheme showing the fastening state of the lamp string on the present invention.

FIG. 5 is a solid view showing the second embodiment of the present invention.

FIG. 6 is a scheme showing the using state of the present invention.

FIG. 7 is a part enlarged view of FIG. 6.

### DETAILED DESCRIPTION OF PREFERRED EMBODIMENTS

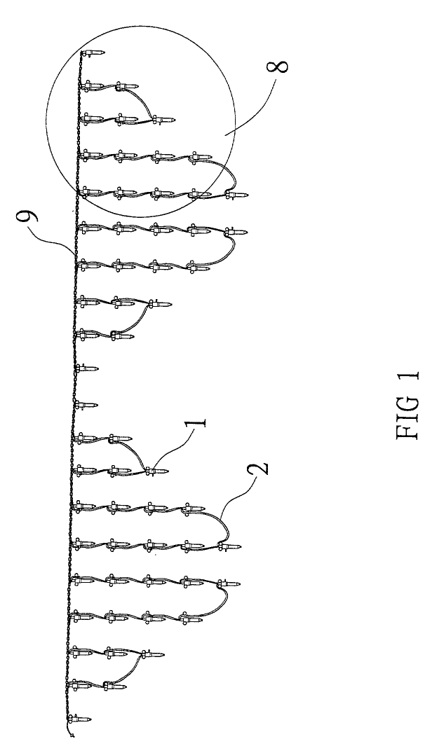

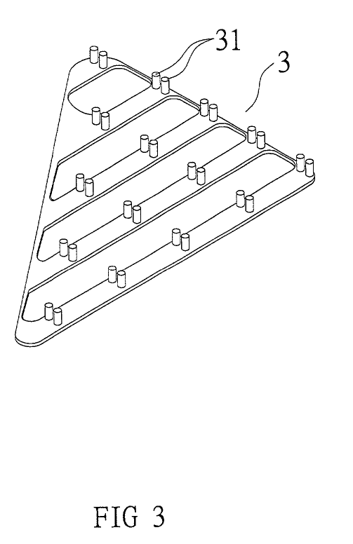

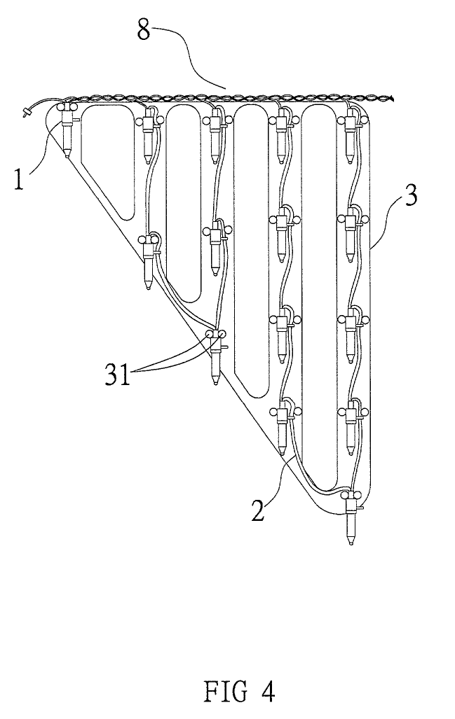

Referring to FIG. 3 and FIG. 4 cooperating to FIG. 1, a holding frame for lamp string is a main frame 3 shaped coordinating to the downward extension of the lamp string—vertical cord units 8; on which there are proper number of plug-in retainers 31 built on said main frame 3 for retaining the lamp-holders 1.

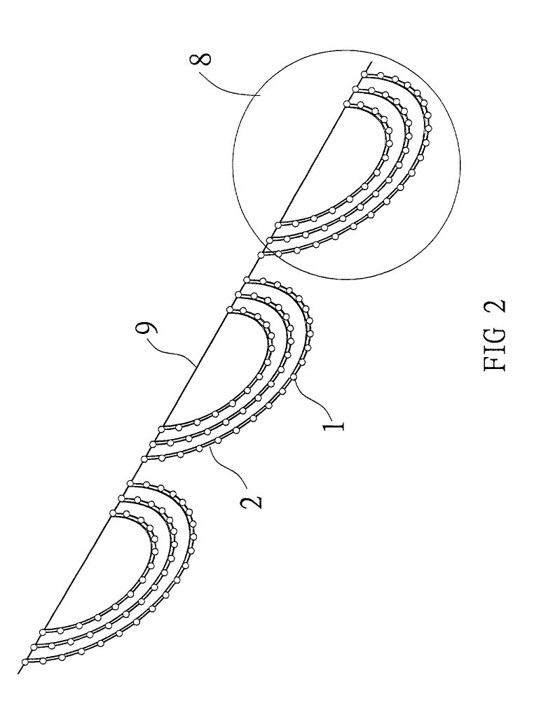

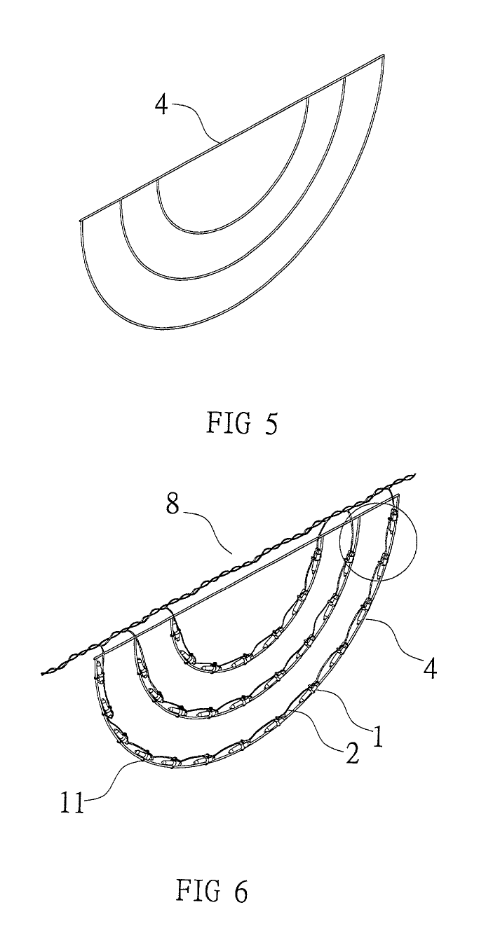

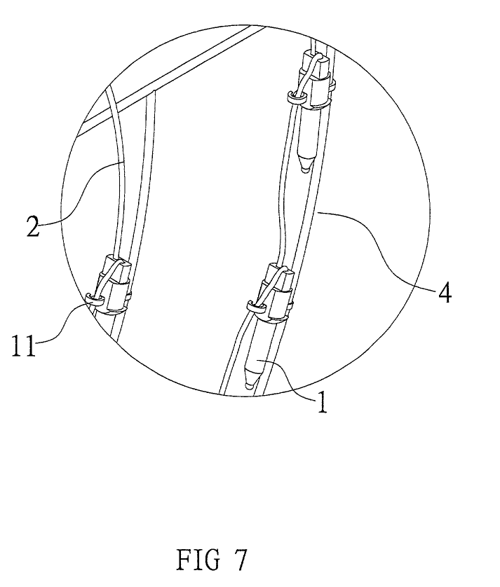

Referring to FIG. 5 to FIG. 7 cooperating to FIG. 2, shown the second embodiment of the present invention is a main frame 4 shaped coordinating to the downward extension of the lamp string—vertical cord units 8, and there is a hooked retainer 11 formed on the each lamp-holder 1 for retaining on said main frame 4.

When packaging process in manufacture, by taking the advantage of said plug-in retainers 31 of said main frame 3, fasten the lamp-holders 1 and the cords 2 of said wired cord unit 8 of coordinating segment of said lamp string on said main frame 3; or by taking the advantage of said hooked retainer on every lamp-holder 1, fasten the lamp-holders 1 and the cords 2 of said wired cord unit 8 of coordinating segment of said lamp string on the coordinating positions of said main frame 4 sequentially, until all length of the lamp string is fastened on said main frames 3 or 4, then fold up the adjutant main frames 3 or 4 to stack up in the package one by one to finish the packaging process.

When the user wants to take the lamp string out of package, it is easy to be picked up as one piece of mainframe as one unit so that the lamp-holders 1 or the cords 2 will not kink together and distort. It not only saves the time and the labor of the users, but also restores the lamp string into the original state easily.

I claim:

1. A lamp string holding frame, wherein it is a main frame shaped coordinating to the downward extension of the lamp string—vertical cord units; there are a proper number of retainers built on said main frame or the each wired lamp-holder for fastening them together.
